(19) United States
(12) Patent Application Publication
(10) Pub. No.: US 2019/0217833 A1
(43) Pub. Date: Jul. 18, 2019

(54) Air Treatment Unit for a Brake System of a Utility Vehicle, and Method for Operating an Air Treatment Unit

(71) Applicant: KNORR-BREMSE Systeme fuer Nutzfahrzeuge GmbH, Muenchen (DE)

(72) Inventors: Max MICHALSKI, Neubiberg (DE); Andreas LEINUNG, Muenchen (DE)

(21) Appl. No.: 16/359,386

(22) Filed: Mar. 20, 2019

Related U.S. Application Data
(63) Continuation of application No. PCT/EP2017/071286, filed on Aug. 24, 2017.

(30) Foreign Application Priority Data
Sep. 21, 2016 (DE) 10 2016 117 836.5

(51) Int. Cl. B60T 8/34; B60T 8/1761; B60T 17/00; B60T 8/32; B60T 8/96; B60T 13/68

(52) U.S. Cl. CPC B60T 8/342; B60T 8/1761; B60T 17/002; B60T 8/329; B60T 2270/413; B60T 13/683; B60T 2270/10; B60T 2270/403; B60T 8/96

(57) ABSTRACT

An air treatment unit for a brake system of a utility vehicle includes a foot brake module connection for pneumatically coupling the air treatment system to a foot brake module of the brake system, at least one valve unit for supplying the foot brake module connection with a control pressure, and a control device for controlling the valve unit.

### CROSS REFERENCE TO RELATED APPLICATIONS

This application is a continuation of PCT International Application No. PCT/EP2017/071286, filed Aug. 24, 2017, which claims priority under 35 U.S.C. § 119 from German Patent Application No. 10 2016 117 836.5, filed Sep. 21, 2016, the entire disclosures of which are herein expressly incorporated by reference.

### BACKGROUND AND SUMMARY OF THE INVENTION

The present invention relates to an air treatment unit for a brake system of a utility vehicle, and to a method for operating an air treatment unit.

A utility vehicle can have a brake system which can be automatically controlled by an electronic brake system. In the event of failure of the electronic brake system, the automatic control of the brake system can be maintained, for example, by a redundant electronic control unit having a separate power supply.

Against this background, with the approach presented here an air treatment unit for a brake system of a utility vehicle, a method for operating an air treatment unit, and a corresponding computer program are presented according to the main claims. Advantageous developments and improvements of the apparatus specified in the independent claim are possible by the measures cited in the dependent claims.

An air treatment unit for a brake system of a utility vehicle is presented, wherein the air treatment unit has the following features:
a foot brake module connection for pneumatically and/or electrically coupling the air treatment unit to a foot brake module of a brake system of the utility vehicle;
at least one valve unit for charging the foot brake module connection with a control pressure; and
a control device for activating the valve unit.

An air treatment unit can be understood as meaning a unit for cleaning or drying air for operating the brake system. For example, the air treatment unit can be an electronic air treatment unit (EAC). A utility vehicle can be understood as meaning, for example, a truck, a bus, a tractive unit or a crane truck. The utility vehicle can be, for example, a vehicle with a partially or fully automated drive. The utility vehicle can be equipped, for example, with an anti-lock brake system (ABS) or an electronic brake system (EBS). A foot brake module can be understood as meaning a brake system component which is equipped with a foot pedal for actuation of the brake system by a driver. A control pressure can be understood as meaning, for example, a pressure differing from an operating pressure of the brake system. In particular, the control pressure can be lower than the operating pressure. The valve unit can be, for example, an electrically activatable solenoid valve. A control device can be understood as meaning an electric device which processes sensor signals and, in dependence thereon, outputs control and/or data signals. The control device can have an interface, which can be embodied by hardware and/or software. In a hardware implementation, the interfaces can be, for example, part of what is referred to as an ASIC system which encompasses a wide variety of functions of the control device. However, it is also possible for the interfaces to be dedicated integrated circuits, or to be at least partially composed of discrete components. In the case of a software implementation, the interfaces can be software modules which are present, for example, on a microcontroller in addition to other software modules. Furthermore, it is conceivable for the one external valve assembly which is electrically activated via an air treatment housing interface and, for its part, pneumatically activates the foot brake module to likewise be able to be realized with an approach presented here.

The approach presented here is based on the finding that a foot brake module of a brake system of a utility vehicle can be pneumatically activated by an air treatment unit of the brake system in the event of failure of an electronic brake system. It is therefore possible, with relatively little additional outlay, to realize a redundant braking function of the brake system that can be used, for example, in conjunction with autonomous driving as a fallback level.

According to one embodiment, the control device can be coupled or couplable to at least one wheel rotational speed sensor of the utility vehicle and can be designed to activate the valve unit or, additionally or alternatively, at least one control valve of an anti-lock brake system of the utility vehicle using a wheel rotational speed sensor signal generated by the wheel rotational speed sensor. A wheel rotational speed sensor can be understood as meaning, for example, a pole wheel sensor. The wheel rotational speed sensor signal can represent a rotational speed of an individual wheel of the utility vehicle. The control valve can be connected, for example, upstream of an individual wheel brake cylinder of the brake system. This embodiment permits specific braking of individual wheels of the utility vehicle by means of the air treatment unit. This makes it possible to avoid the wheels of the utility vehicle locking during braking. As a precursor to the use of the rotational speed signal, the control would be close to locking without use of the ABS valves simply axle by axle via the foot brake module. One possible disadvantage would then be, however, that firstly it is possible only for the wheel with the lower static coefficient of friction to be controlled, which extends the braking distance. At the same time, the axle with the low coefficient of friction should then also still be controlled because of the ratio, determined via the foot brake module, of front axle pressure to rear axle pressure, which would also be suboptimal.

The control device here can be designed to activate the valve unit or, additionally or alternatively, the control valve using the wheel rotational speed sensor signal, in such a manner that the utility vehicle is braked and/or steered on one side. As a result, a steering brake function can be realized using the air treatment unit.

Furthermore, the air treatment unit can have a distribution unit for distributing air treated by the air treatment unit to at least one brake circuit assigned to a service brake of the brake system, and at least one connecting line for connecting the distribution unit to the foot brake module connection. The valve unit can be arranged in the connecting line. In particular, the connecting line can be part of the brake circuit. A service brake can be understood as meaning a brake acting on all of the wheels of the utility vehicle. The service brake can comprise, for example, separate brake circuits for a front axle and a rear axle of the utility vehicle. The distribution unit can be a component with an air inlet for admitting the treated air and at least one output, which is connected to the air inlet, for connecting the distribution unit to the brake circuit. Depending on the embodiment, the distribution unit can have a plurality of outputs for connecting the distribution unit to a plurality of brake circuits, for example also to a parking or trailer brake circuit. This embodiment makes it possible to ensure reliable charging of the foot brake module connection with the control pressure. Furthermore, a relatively simple integration of the valve unit in the pneumatic system of the air treatment unit is thereby made possible, which reduces the production costs of the air treatment unit. However, it is furthermore also conceivable for the foot brake module connection and the valve unit located in-between to also be connected at the same time to the storage container of said consumer circuit. This connection is functionally likewise relevant because there is a volume behind the generated pressure so that, in the event of a desired pressure rise, the pressure upstream of the control valve does not collapse. In this respect, the volume of a storage container which is not present upstream of and in the distribution unit is also relevant to the function. A valve unit which is electrically activated by the air treatment but is supplied with a compressed air supply outside the treatment housing is furthermore also conceivable.

It is furthermore advantageous if the control device is designed to activate the valve unit in response to a failure of an electronic brake system of the utility vehicle. As a result, sufficient braking power of the brake system can be ensured even if the electronic brake system fails. Since the electronic brake system (EBS) and the control of the service brake via the foot brake module (FBM) and the electronic air treatment/electronic air control, EAC for short, are functionally equivalent, in the event of autonomous driving braking could normally be carried out with the EAC/FBM and, in the event of failure of this system, could be realized with the EBS.

According to a further embodiment, the air treatment unit can have at least one additionally connection for pneumatically coupling the air treatment unit to a parking and/or trailer brake circuit of the brake system, and at least one additional valve unit for charging the additional connection with an additional control pressure. The control unit can correspondingly be designed to also activate the additional value unit. The reliability of the brake system can thereby be further increased.

In addition, the approach presented here provides a method for operating an air treatment unit according to the one of the above embodiments, wherein the method comprises the following step:

generating a control signal in order to activate the valve unit in such a manner that the foot brake module connection is charged with the control pressure.

Also advantageous is a computer program product or computer program having program code, which can be stored on a machine-readable carrier or storage medium, such as a semiconductor memory, a hard drive memory or an optical memory, and which is used for carrying out, realizing and/or activating the steps of the method according to one of the embodiments described above, in particular if the program product or program is executed on a computer or an apparatus.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1A shows a schematic illustration of a brake system with an air treatment unit according to an embodiment of the present invention.

FIG. 1B shows a schematic illustration of a valve unit for an air treatment unit according to an embodiment of the present invention.

FIG. 2 shows a schematic illustration of a brake system with an air treatment unit according to an embodiment of the present invention.

FIG. 3 shows a schematic illustration of a control device according to an embodiment of the present invention.

FIG. 4 shows a flow diagram of a method according to an embodiment of the present invention.

### DETAILED DESCRIPTION OF THE DRAWINGS

In the description below of advantageous embodiments of the present invention, identical or similar reference signs are used for the similarly acting elements illustrated in the various figures, with a repeated description of said elements being dispensed with.

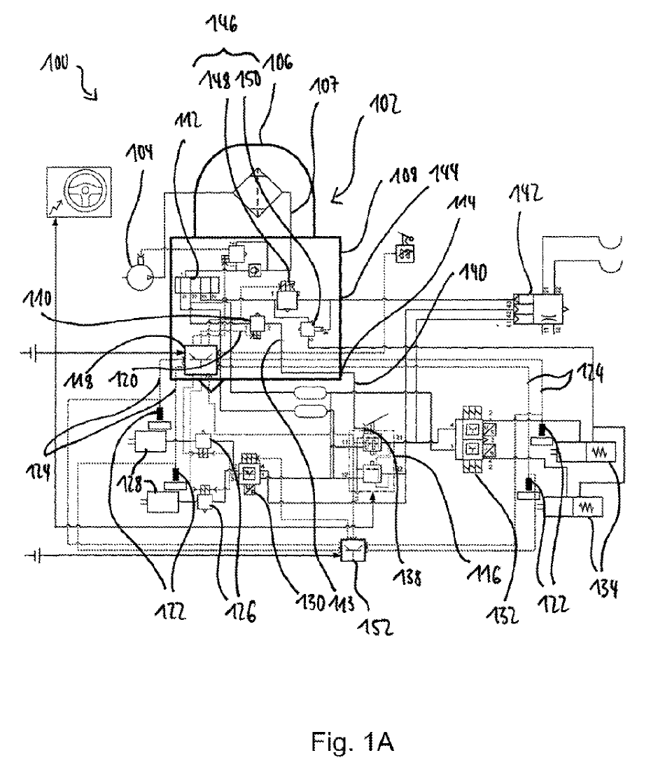

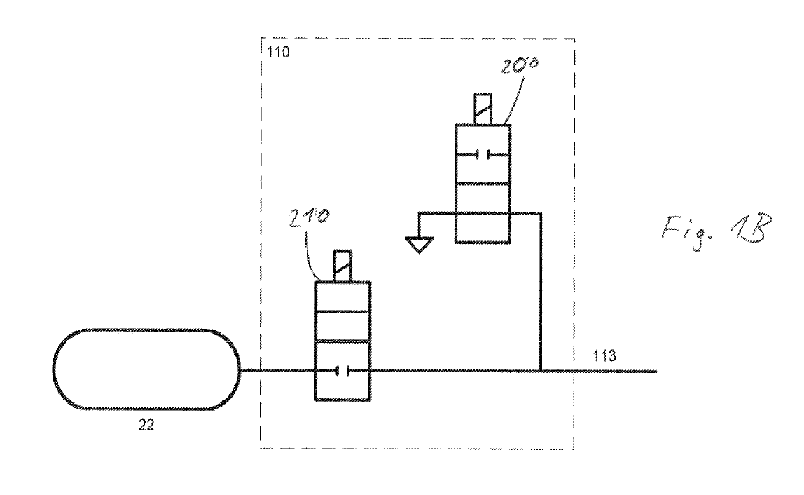

In FIGS. 1 and 2 described below, lines for electric signal transmission are indicated by dotted lines, pneumatic lines by continuous lines and lines for transmitting electrical energy by arrow-shaped lines. Optional connections are indicated by partially dashed, partially dotted lines.

FIG. 1A shows a schematic illustration of a brake system 100 of a utility vehicle with an air treatment unit 102 according to an exemplary embodiment. The air treatment unit 102 comprises a filter cartridge 106, which is connected to a compressor 104, for filtering and drying compressed air provided by the compressor 104. The filter cartridge 106 is arranged on a housing 108 of the air treatment unit 102 and is pneumatically connected to the housing 108 via a filter cartridge line 107. Arranged in the housing 108 is a valve unit 110 indicated, for example, as a combination of two solenoid valves 200 and 210, with which the three states—pressure buildup, maintaining the pressure and pressure dissipation—are possible.

FIG. 1B shows a valve unit 110 configured in such a manner, in which, in the unenergized state, because of the arrangement of the two solenoid valves 200 normally open and 210 normally closed, the line 113 is vented, which is systemically necessary since, normally, i.e. when the valve unit 110 is unenergized, the automatic brake system does not override the driver's intentions. The valve unit 110 is connected to the filter cartridge line 107 via a distribution unit 112. A connecting line 113 connects the distribution unit 112 to a foot brake module connection 114 of the housing 108. The valve unit 110 is arranged here in the connecting line 113. By way of example, the connecting line 113 is designed as part of a brake circuit assigned to a service brake of the brake system 100. A foot brake module 116 of the brake system 100 is connected to the air treatment unit 102 via the foot brake module connection 114. The valve unit 110 is designed to charge the foot brake module connection 114 with a control pressure for pneumatically activating the foot brake module 116. A control device 118 which is likewise arranged in the housing 108 is designed to activate the valve unit 110 by outputting a corresponding control signal 120.

According to this embodiment, the control device 118 is coupled by way of example to a total of four wheel rotational speed sensors 122 for detecting a rotational speed of one wheel each of the utility vehicle. The wheel rotational speed sensors 122 each send a wheel rotational speed sensor signal 124, which represents the respective rotational speed of the wheels, to the control device 118, wherein the control device 118 is designed to activate the valve unit 110 using the wheel rotational speed sensor signals 124, i.e. depending on the respective rotational speed of the wheels.

The utility vehicle is equipped with an anti-lock brake system which, according to FIG. 1, comprises, by way of example, two control valves 126 for controlling a supply of compressed air to in each case one of two front axle brake cylinders 128 of a front axle of the utility vehicle. According to one exemplary embodiment, the control device 118 is designed to directly electrically activate the control valves 126 using the wheel rotational speed sensor signals 124, in particular in such a manner that locking of the front wheels during braking of the utility vehicle via the foot brake module 116 is avoided. Alternatively, the control valves 126 are activated by the control device 118 in such a manner that the utility vehicle is braked on one side. A steering brake function can thereby be realized by the air treatment unit 102.

The foot brake module 116 is pneumatically coupled via a front axle valve module 130, which is connected upstream of the two control valves 126, to the two front axle brake cylinders 128 and is pneumatically coupled via a rear axle valve module 132 to two rear axle brake cylinders 134 for braking one rear wheel each of the utility vehicle. By way of example, the two rear axle brake cylinders 134 are designed to lock the rear wheels in the vented state by means of spring force. In this connection, what are referred to as combination brake cylinders are illustrated in FIG. 1A, said combination brake cylinders having a first input (here on the left) for actuating the service brake cylinder with (positive) pressure and without spring force, and a second input for actuating the parking brake cylinder for releasing the parking brake spring force under pressure or for engaging the parking brake without pressure via the spring force. The rear axle brake cylinders 134 therefore act both as a service brake and as a parking brake. A corresponding operating pressure for actuating the four brake cylinders 132, 134 is provided via the distribution unit 112 which is connected to the foot brake module 116 parallel to the foot brake module connection 114 via corresponding pneumatic lines. The foot brake module 116 has a separate control connection 138 which is pneumatically coupled to the foot brake module connection 114 via a control line 140.

The foot brake module 116 according to FIG. 1A is connected by way of example to a trailer valve module 142 for charging the trailer brake with a corresponding control pressure. A trailer and parking brake circuit often refers here to the entire consumer line which, beginning from the multi-circuit protective valve or the distribution unit 112, leads as a circuit 23 to, on the one hand, the control line of the trailer control module 142 and, on the other hand, to the parking brake of the tractive unit, which parking brake, as can be seen in FIG. 1A, leads via the solenoid valve 148 and the relay valve 150 to the parking brake cylinders. The trailer valve module 142 is pneumatically coupled here via an additional connection 144 of the housing 108 to an additional valve unit 146 arranged in the housing 108, wherein said additional valve unit equally corresponds to the electric parking brake. The additional valve unit 146 for its part is connected to the distribution unit 112. By way of example, the additional valve unit 146 is realized via a solenoid valve unit with three switchable solenoid valves and a relay valve 150. In this connection, the notch in the right electrical control connection of the solenoid valve unit is intended to indicate the bistability of the electric parking brake which is therefore stable both in the parking position and in the released position, with a bistable solenoid valve not being needed. A bistable parking brake pneumatically pilot-controlled via three solenoid valves can also be realized. The relay valve 150 is additionally pneumatically coupled to the two rear axle brake cylinders 134. The solenoid valve 148 in this respect pilot-controls the relay valve, which has an air-quantity-increasing effect, and therefore the desired pressure value controlled by the electronics unit 118 can also be adjusted with a sufficiently rapid air quantity flow in the large brake cylinders. The relay valve 150 pneumatically-mechanically with a large cross section follows the desired value which is input at its control connection.

The brake system 100 shown in FIG. 1A is activatable automatically by an electronic brake system, EBS for short. The electronic brake system comprises an EBS control device 152 which, for electric signal transmission, is connected by way of example to the foot brake module 116, the front axle valve module 130 and the four wheel rotational speed sensors 122.

According to one embodiment, the control device 118 is designed in order to activate the valve unit 110 if the electronic brake system fails.

FIG. 2 shows a schematic illustration of a brake system 100 for a utility vehicle with an air treatment unit 102 according to an embodiment. The brake system 100 substantially corresponds to the brake system described above with reference to FIG. 1A. In contrast to FIG. 1A, FIG. 2 illustrates a brake system that does not have what is referred to as the EBS, but rather a simple brake system with ABS. The “main use” of the EBS is the comfortable and always identical braking of the entire brake system irrespective of the loading state. In old brake systems, the purely pneumatic and also the ABS brake system, the distribution of the service braking force depends on the invariable characteristics of “pedal travel at desired pressures” and of the foot brake module. If the vehicle loading has increased, the intention is for the driver to brake significantly more powerfully. The brake system shown in FIG. 2 also has the same braking characteristic of just one anti-lock brake system. If individual wheels lock because the driver is braking too powerfully, even with an ABS system, however, individual wheels of the vehicle can be braked and in this respect the vehicle can be reliably brought to a standstill even on ice. In this respect, FIG. 2 is intended to show that the invention is also suitable for an ABS. In this connection, the anti-lock brake system according to FIG. 2 comprises, in addition to the two control valves 126, two further control valves 200 which are connected upstream of one of the two rear axle brake cylinders 134 in each case. All of the wheels of an ABS system are always intended to be controlled. This is therefore unnecessary at the rear axle in the case of the EBS system because the double-channel pressure control module uses its two channels to likewise control individual wheels on both sides of the rear axle. The four control valves 126, 200 can be activated by an ABS control device 202. As in FIG. 1A, the two control valves 126 of the front axle can additionally be activated here via the control device 118 of the air treatment unit 102, for example if the ABS control device 202 fails. The two further control valves 200 can optionally also be activated via the control device 118.

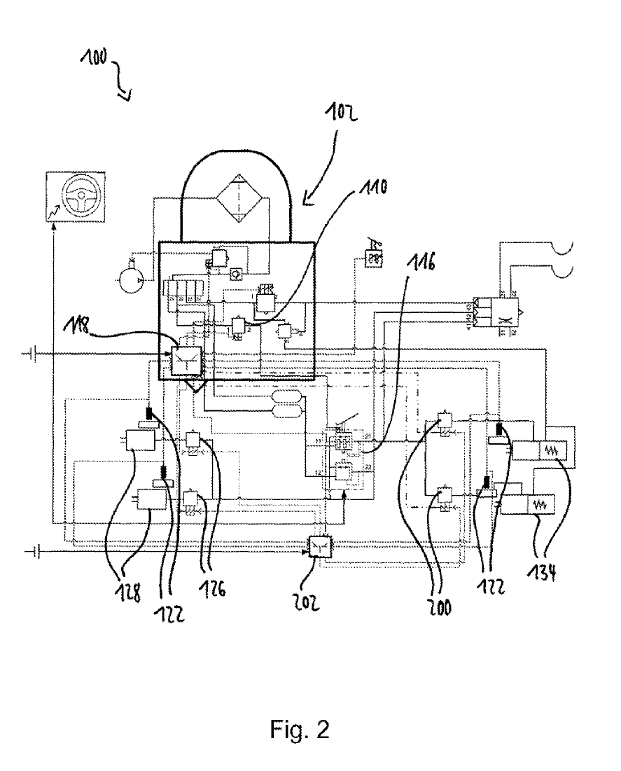

FIG. 3 shows a schematic illustration of a control device 118 according to an embodiment, for example a control device described previously with reference to FIGS. 1A and 2. The control device 118 comprises a generating unit 310 for generating the control signal 120. The control device 118 optionally comprises a reading unit 320 for reading the wheel rotational speed sensor signals 124 and transmitting the wheel rotational speed sensor signals 124 to the generating unit 310. The generating unit 310 here is designed in order to generate the control signal 120 using the wheel rotational speed sensor signals 124.

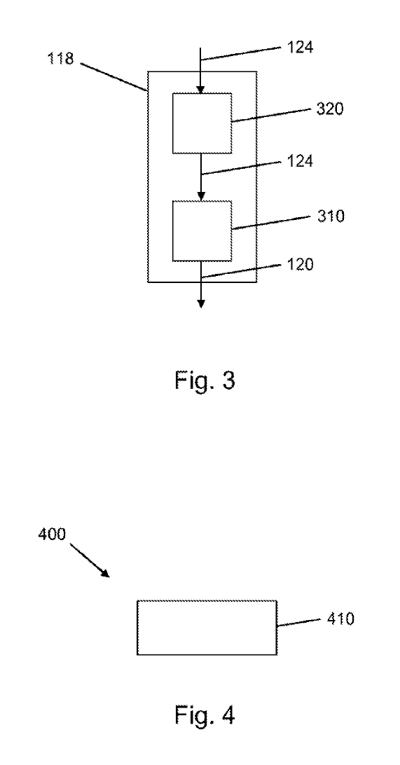

FIG. 4 shows a flow diagram of a method 400 for operating an air treatment unit according to an exemplary embodiment. The method 400 can be carried out, for example, in conjunction with a control device described above with reference to FIGS. 1 to 3. The method 400 comprises a step 410 in which the control signal is generated for activating the valve unit of the air treatment unit.

Various embodiments of the approach presented here will be described once again below in other terms.

The approach presented here permits the development of a cost-effective automatic brake system taking into account an electronic air treatment of a utility vehicle. In particular, the approach presented here is suitable in order, proceeding from previously known systems, to provide electronic redundancy of the brake system, the electronic redundancy being necessary for autonomous driving. Autonomous driving can be understood as meaning electronically assisted driving to completely independent acceleration, steering and braking of the vehicle independently of driver intervention.

Simpler driver assistance functions which are already known include, for example, the anti-lock brake system (ABS), the brake assistant, the electronic brake system (EBS) and also vehicle stabilization functions, such as roll-over protection. The driver is always present here and is also responsible and is only electronically assisted in order to increase the driving comfort and in critical situations.

As the influence of the electronics increases, the legally prescribed requirements regarding the safety and the redundancy of electronic systems also increase. In the case of conventional electronic brake systems, the battery supply can be designed in a simple manner. As a fallback level in the event of electrical errors, the vehicle can also be, for example, braked purely pneumatically.

In the case of driver assistance functions having greater intervention and limited driver attention, such as, for example, platooning, stop-and-go autorelease or autopark or an emergency stopping assistant, or even without presence of a driver, such as during yard maneuvering, this is no longer possible since the fallback level is intended to likewise operate intelligently.

At least one electronic fallback level is therefore required, and the question is posed of how many components of the electronic system should be redundant. The braking power of the fallback level can turn out to be much lower here as long as the vehicle can still be safely controlled.

In this respect, it is the object of the approach presented here, in the realization of an automatic brake system for autonomous driving, to find a good combination of cost-effective use of components already present, required braking power in the event of failure of the first electronic level of the brake system (i.e. if the second redundant electronic system is intended to take on the braking/i.e. in the event of redundancy or also called backup situation), and maximum safety on the basis of the shortest possible braking distance.

The arrangement of the electronic brake activation in the air treatment unit 102 which is present in any case saves the use of additional components which would otherwise have to be provided in different assemblies of the brake activation unit. The electronic brake controller can therefore also be present or formed redundantly in the electronic air treatment. At the same time, use can be made of synergies which arise through the components located in the air treatment unit 102, such as, for example, the integrated parking brake.

The air treatment unit 102 comprises a valve unit 110 which, in the event of failure of the electronic brake system, can use software logic, implemented in the control device 118, which is likewise arranged in the air treatment unit 102, to input, in particular increase, a pressure for the two service brake circuits independently of a driver's intentions, and therefore the vehicle can be safely brought to a standstill even if the driver no longer has the vehicle under control. Alternatively, depending on the design of the control connection 138 of the foot brake module 116, the pressure for the two service brake circuits can also be reduced via the valve unit 110.

By shifting this fallback level into the air treatment unit 102, the outlay on changes to an already existing electronic foot brake module can be kept very low. All that is needed is to provide a further pneumatic control input in the form of the control connection 138. Further valves, a separate control device and cabling associated therewith can therefore be omitted.

In contrast to purely electronic foot brake modules, in which an electronic brake signal is transmitted to electronic brake control devices, the approach presented here provides a pneumatic fallback level for the service brake, as a result of which the automatic braking concept becomes safer because, even in the event of failure of both voltage supplies or both electronic systems (the failure causes could lie outside the voltage supplies in both cases), the vehicle can still be braked by the driver in a metered manner via the second fallback level. Also, in the event of nonresolvable electrical error situations, the voltage supplies could be consciously switched off in order for the vehicle to be able to be safely braked/parked purely pneumatically by a driver, which is not possible in systems having purely electrical systems. The control device 118 is optionally designed for redundant reading of the wheel rotational speed sensor signals 124, which are provided, for example, by pole wheel sensors as wheel rotational speed sensors 122, and for redundant electrical activation of the ABS valves 122. This has the advantage that, in the event of failure of the electronic brake system, ABS control can be ensured via the air treatment unit 102 if the software of such an ABS control logic is implemented in the control device 118.

By evaluation of the wheel rotational speed sensor signals 124 in the control device 118, it can be ensured, for example, that the braking distance is greatly shortened in the event of failure of the electronic brake system since the wheel slip is known and the braking pressure can therefore be increased to such an extent that the wheels now do not lock.

By way of example, no ABS valves with which locking of the rear wheels could be prevented are shown in FIG. 1 on the rear axle of the utility vehicle. Only the wheel rotational speed sensors 122 are shown. Nevertheless, even without ABS valves at the rear axle, the vehicle deceleration can be optimized solely on account of the present wheel rotational speed sensor signals 124 of the wheel rotational speed sensors 122 on the rear axle. By controlling the pressure, which is input via the foot brake module 116, to the slip of the rear axle and toleration of a possibly significantly increased preliminary pressure at the front axle, locking can be prevented with the aid of the control valves 126. The ratio between front and rear axle pressure is preset in an invariable manner via the pneumatics of the foot brake module 116.

With regard to the requirements of autonomous driving, this system permits braking interventions on one side of a steered front axle even in the event of failure of the electronic brake system if the pressure input via the foot brake module 116 is vented at the same time on one side by the air treatment unit 102 via one of the ABS valves 126 in order to realize brake steering.

Further synergies arise in conjunction with an electronic parking brake (EPB) which is optionally integrated in the air treatment unit 102. While only the two service brake circuits are actuated via the additional pneumatic feeding of a control pressure into the foot brake module 116, in the event of failure of the electronic brake system and the associated voltage supply, adapted to the two service brake circuits, a trailer or handbrake circuit can also be activated by the control device 118.

This provides further scope of designing an optimized braking distance against the background of the pressure ratio, which is fixedly predetermined by the pneumatic foot brake module 116, between front and rear axle. In the event of a high frictional value and high load on the rear axle, the brake force is intended to be of a corresponding magnitude, which at the same time can mean a possibly too high control pressure for the anti-lock brake system at the front axle. By division of the braking forces at the rear axle between parking brake and service brake, the control pressure at the front axle can be reduced upstream of the ABS valves 126.

In addition, driver assistance functions can be ended with application of the parking brake or begun with release of the parking brake, which can be of advantage both for yard maneuvering and for safely parking the vehicle after emergency braking.

According to a further embodiment, the control device 118 is designed in order, in the event of emergency braking, to simultaneously control functions of the air treatment depending on the situation. Thus, after safe parking of the vehicle, for example, the storage containers of the brake system 100 can be vented by the control device 118 so that the compressed air of the possibly already damaged vehicle does not constitute any risk for rescue teams. Similarly, after the end of yard-maneuvering operations or prior to switching off the ignition, the filter cartridge 106 can be regenerated by activation of corresponding valves in the air treatment unit 102 by the control device 118 in order to increase the durability of the filter cartridge 106.

For example, the wheel rotational speed sensor signals 124 are transmitted in parallel to two different control devices: to the control device 118 and the EBS control device 152 in FIG. 1 and to the control device 118 and the ABS control device 202 in FIG. 2. It is advantageous here for minimizing the cabling if the air treatment unit 102 can pick up the wheel rotational speed sensor signals 124 in the vicinity of the pressure control modules. Alternatively, the wheel rotational speed sensor signals 124 are transmitted by the electronic brake system via a gateway which is supplied, for example, in an electrically separated manner from the electronic brake system.

If an embodiment includes an “and/or” link between a first feature and a second feature, this should be read in such a manner that the embodiment according to one embodiment has both the first feature and the second feature and, according to a further embodiment, has either only the first feature or only the second feature.

### LIST OF REFERENCE SIGNS

100 Brake system
102 Air treatment unit
104 Compressor
106 Filter cartridge
107 Filter cartridge line
108 Housing
110 Valve unit
112 Distribution unit
113 Connecting line
114 Foot brake module connection
116 Foot brake module
118 Control device
120 Control signal
122 Wheel rotational speed sensor
124 Wheel rotational speed sensor signal
126 Control valve
128 Front axle brake cylinder
130 Front axle valve module
132 Rear axle valve module
134 Rear axle brake cylinder
138 Control connection
140 Control line
142 Trailer valve module
144 Additional connection
146 Additional valve unit
148 Solenoid valve
150 Relay valve
152 EBS control device
200 Further control valve
202 ABS control device
310 Generating unit
320 Reading unit
400 Method for operating an air treatment unit
410 Generating step

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. An air treatment unit for a brake system of a utility vehicle, comprising:
a foot brake module connection configured to couple the air treatment unit one or more of pneumatically and electrically to a foot brake module;
at least one valve unit for charging the foot brake module connection with a control pressure to activate the foot brake module; and
a control device configured to activate the at least one valve unit.

2. The air treatment unit as claimed in claim 1, wherein
the control device is coupleable to at least one wheel rotational speed sensor of the utility vehicle, and
the control device is configured to activate one or more of the at least one valve unit and at least one control valve of an anti-lock brake system of the utility vehicle using a wheel rotational speed sensor signal generated by the wheel rotational speed sensor.

3. The air treatment unit as claimed in claim 2, wherein
the control device is configured to activate one or more of the at least one valve unit and the control valve using the wheel rotational speed sensor signal such that the utility vehicle is one or more of braked and steered on one side.

4. The air treatment unit as claimed in claim 3, further comprising:
a distribution unit configured to distribute air treated by the air treatment unit to at least one brake circuit assigned to a service brake of the brake system (100); and
at least one connecting line arranged to connect the distribution unit to the foot brake module connection (114),
wherein
the connecting line is part of one of a plurality of brake circuits of the utility vehicle,
the valve unit is arranged in the connecting line, and
the valve unit is configured to be fed from the plurality of brake circuits.

5. The air treatment unit as claimed in claim 4, wherein
the control device is configured to activate the valve unit in response to a failure of an electronic brake system of the utility vehicle.

6. The air treatment unit as claimed in claim 5, further comprising:
at least one additional connection configured to pneumatically couple the air treatment unit to one or more of a parking brake circuit and a trailer brake circuit of the plurality of brake circuits, and
at least one additional valve unit configured to charge the additional connection with an additional control pressure,
wherein the control device is further configured to activate the additional valve unit simultaneously with the foot brake module.

7. The air treatment unit as claimed in claim 6, wherein
the valve unit when not energized has an unpressurized output.

8. The air treatment unit as claimed in claim 7, wherein
the control device is further configured to read rotational speed signals via redundant additional rotational speed sensors configured to supply information to an electronic air treatment unit.

9. The air treatment unit as claimed in claim 7, wherein
the control device is configured to read rotational speed signals of a sensor of the at least one wheel rotational speed sensors which supplies rotational speed signals to one or more of an ABS and an EBS system of the utility vehicle.

10. The air treatment unit as claimed in claim 7, wherein
the control device is configured to read at least one rotational speed sensor signal from the at least one wheel rotational speed sensors via a CAN data bus.

11. A method for operating an air treatment unit, the air treatment unit including a foot brake module connection configured to couple the air treatment unit one or more of pneumatically and electrically to a foot brake module, at least one valve unit for charging the foot brake module connection with a control pressure to activate the foot brake module, and a control device configured to activate the at least one valve unit to activate the foot brake module, comprising the act of:
generating a control signal to activate the valve unit such that the foot brake module connection is charged with the control pressure.

12. A machine-readable storage medium on which is stored a computer program configured to one or more of carry out and activate the method of claim 11.
